(19) United States
(12) Patent Application Publication
(10) Pub. No.: US 2021/0287172 A1
(43) Pub. Date: Sep. 16, 2021

(54) System and Method for Selecting a Distribution Centre for Delivery of Goods to a Destination Address

(71) Applicant: Delhivery Private Limited, Gurgaon (IN)

(72) Inventor: Kabir Rustogi, New Delhi (IN)

(73) Assignee: Delhivery Private Limited, Gurgaon (IN)

(21) Appl. No.: 17/064,657

(22) Filed: Oct. 7, 2020

(30) Foreign Application Priority Data
Mar. 16, 2020 (IN) 202011011136

(51) Int. Cl. G06Q 10/08; G06Q 10/04

(52) U.S. Cl. CPC G06Q 10/08355; G06Q 10/047; G06Q 10/0838

(57) ABSTRACT

Disclosures in the present invention relate to a system and method of efficiently selecting a distribution centre for making a delivery to a destination address. Mapping data, which reflects the ease of making a delivery from a distribution centre to a destination address is stored for each destination-distribution pair. The mapping data comprises of historical delivery data as well as route data. The system updates the mapping data periodically, randomly or on-need basis. The system selects a distribution centre from which the delivery to a destination address can be made in the most efficient manner.

### CROSS-REFERENCE TO RELATED APPLICATIONS

This non-provisional patent applications claims the benefit of and priority to Indian Patent Application Serial No. 202011011136, filed Mar. 16, 2020, entitled “System and Method for Selecting a Distribution Centre for Delivery of Goods to a Destination Address,” the entire contents of which is hereby incorporated herein by reference.

### FIELD OF INVENTION

Embodiments of the disclosure relate generally to the field of machine learning and data interpretation. More particularly, embodiments of the disclosure relate to a system, method and apparatus for selecting a distribution centre for efficient delivery of goods to destination addresses.

### BACKGROUND

The ubiquity of personal computers, the Internet, and the World Wide Web as well as the increasing scope of electronic commerce has resulted in striking changes in how trade occurs. Manufacturers, retailers, and distributors must store and deliver great quantities of products at a time. It is not uncommon to have hundreds if not thousands of products. This has given rise to large warehouses catering to wide geographical areas. It is imperative for companies operating in the trade environment between remote parties to establish an effective distribution system. However, the storage and delivery of products to customers distributed across a large geographic area in a timely manner presents significant challenges. Orders are received from customers and material handling systems must locate inventory and then route the inventory necessary to fill the orders to an appropriate location for shipping or delivery. Often, products stored in large warehouses are located far from the delivery address of a customer, leading to longer delivery times or higher delivery costs.

This has given rise to new and innovative logistic models involving first mile logistics, fulfilment, line-hauling, last mile logistics and other models such as dropshipping etc. Despite the advantages, a common drawback of such models is that a parcel gets routed through multiple stations (warehouses, fulfilment centres etc.) before being delivered to the end customer. This increases the chances of parcel being routed through a less efficient path which may result in loss of time, money and may potentially cause loss of customer.

Similarly, in last mile logistics, a customer's destination may be serviced by multiple distribution centres. Choosing a less preferred distribution centre may prolong the delivery time, increase costs and hurt reputation.

Accordingly, there is a need for a system and method to ensure efficient delivery to a destination.

### BRIEF DESCRIPTION OF THE DRAWINGS

Embodiments according to the claimed subject matter are described below with reference to the drawings. The detailed description references the accompanying figures. The same numbers can be used throughout the drawings to reference like features and components. As used herein, like terms refer to like elements throughout the description. It should be noted that views of exemplary embodiments are merely to illustrate selected features of the embodiment. The views qualitatively illustrate exemplary features of some embodiments and, therefore, should not be interpreted as being drawn to scale.

FIG. 1 is a block diagram schematically showing a system according to some embodiments of the present invention.

FIG. 2 illustrates a data storage module according to some embodiments of the present invention.

FIG. 3 illustrates a directed acyclic graph corresponding to address data stored in the data storage module according to some embodiments of the present invention.

FIG. 4 illustrates a distribution centre selection system, according to one embodiment of the present invention.

### SUMMARY

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present some concepts of the invention in a simplified form as a prelude to the more detailed description that is presented later.

It is an object of the invention to provide improved methods for efficient delivery of goods from a distribution centre to a destination address.

According to one aspect of the present invention, there is disclosed a computer system including one or more processing modules. The computer system further comprises one or more data storage modules coupled to the one or more processing modules. The computer system also comprises at least one memory module coupled to the one or more processing modules. The processing modules may be configured to select an origin address data corresponding to an address of a origin entity and a destination address data corresponding to an address of a destination entity; wherein the origin address data is selected based on the mapping data corresponding to the mapping between the destination address data and the origin address data.

The independent claims define the invention in various aspects. The dependent claims state selected elements of embodiments according to the invention in various aspects.

This summary is submitted with the understanding that it will not be used to interpret or limit the scope or meaning of the claims. This summary is not intended to identify key features or essential features of the claimed subject matter, nor is it intended to be used as an aid in determining the scope of the claimed subject matter. Other methods, apparatus and systems are also disclosed. Those skilled in the art will recognise additional features and advantages upon reading the following detailed description, and upon viewing the accompanying drawings.

### DETAILED DESCRIPTION

For purposes of explanation, numerous specific details are set forth in order to provide a thorough understanding of the claimed subject matter. It may be evident, however, that the claimed subject matter may be practised without these specific details. Also, in some instances, well-known features are omitted or simplified to clarify the description of the exemplary implementations. In some other instances, well-known features or units or circuits have been shown in block diagram form in order avoid clutter due to unnecessary detailing.

Reference will now be made to the drawings to describe the present invention in detail. The implementations herein are described in terms of exemplary embodiments. However, it should be appreciated that individual aspects of the implementations may be separately claimed and one or more of the features of the various embodiments may be combined.

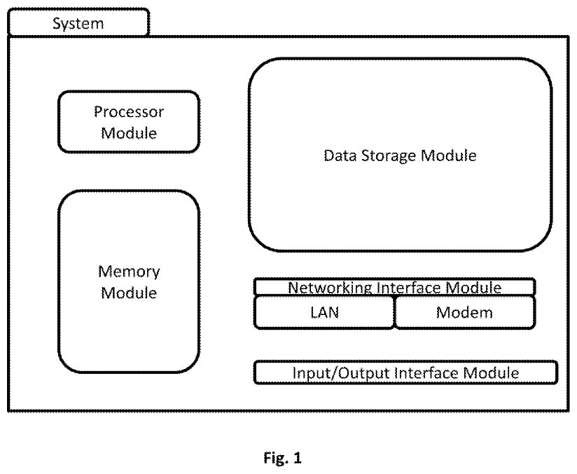

FIG. 1 is a block diagram schematically showing a system according to some embodiments of the present invention. As shown, the system may comprise at least one processing module, one or more data storage modules coupled to the one or more processing module and at least one memory module coupled to the one or more processing modules. The system may further include a networking interface, to allow the system to operate in a networked environment supporting connections to one or more remote computers, such as mobile devices and computing devices. The networking interface may include a modem and a local area network (LAN) interface. The modem and LAN interface may connect to external communication devices, such as mobile phone, computer system and laptops etc. via internet, WAN or other communication modes.

The memory module may be configured to store software used by the system such as an operating system, applications program and associated database. The memory module may further be configured to store instructions, executable by the processing module, for enabling the system to perform various functions.

The system may also include an input-output interface which may include, but not limited to, an interface for display, keyboard, mouse, keypad, speaker, haptic device, microphone, camera or other input-output techniques well known in the art.

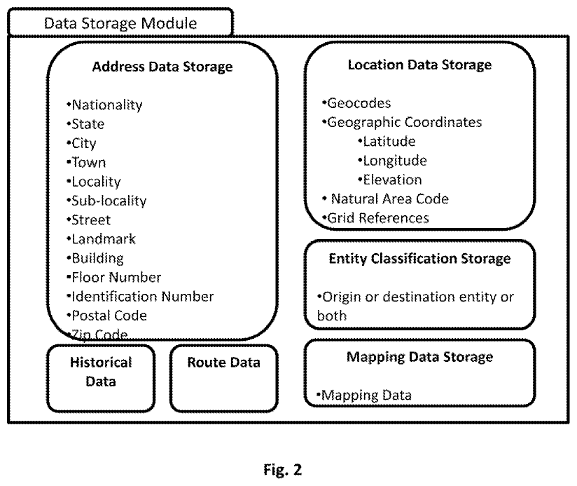

Referring the FIG. 2, there is shown a data storage module according to some embodiments of the present invention. The data storage module may be configured to store address data corresponding to an address of an entity. The address data may include nationality, state, city, town, locality, sub-locality, street, landmark, building, floor number, identification number, postal code, zip code or any other address identifying parameter.

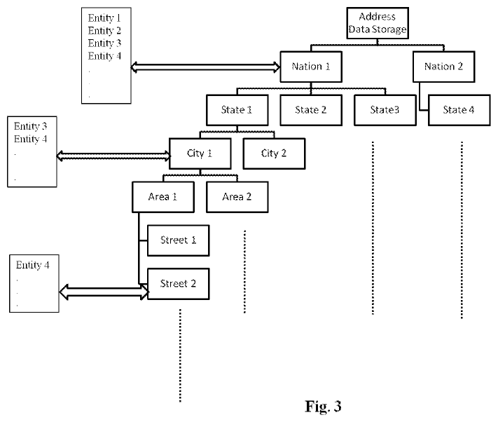

In an embodiment of the present invention, the storage of address data of entities in the data storage module may be implemented in form of a directed acyclic graph. Referring to FIG. 3, the directed acyclic graph corresponding to address data stored in the data storage module is shown. The graph may include a plurality of hierarchical addressing blocks corresponding to at least one of: nationality, state, city, town, locality, sub-locality, street, landmark, building, floor number, identification number, postal code, zip code or any other address identifying parameter well known in the art. A first addressing block may be connected to at least one second addressing block via a parent-child relationship.

Each hierarchical addressing block may link to one or more entities whose address data map on to the hierarchical addressing block. Hence, the hierarchical addressing block named ‘Delhi’ shall list all the entities which have ‘Delhi’ as city in their address data. Similarly, the hierarchical addressing block named ‘Janpath’ shall list all the entities which have ‘Janpath’ as street name in their address data.

The data storage module, as shown in FIG. 2, may also be configured to store location data corresponding to an entity. The location data may include geocodes, geographic coordinates such as latitude, longitude or elevation, natural area code, grid references, or the like.

The entities stored in the data storage module may be classified as origin entities and destination entities. An origin entity refers to a point of dispatch of goods, parcel, mail etc. The origin entity can be a warehouse, storage room, godown, store, depot, or any other storage entity or distribution centre of the type. Each origin entity may or may not have a well-defined/loosely defined geographical area which represents the area that the origin entity may cater to. A destination entity refers to the end point where the goods, parcel, mail etc. are to be delivered. Typical examples include, but not limited to, houses, apartments, residential buildings, offices, commercial buildings, shops, industrial buildings and so on. The origin entity may also be a destination entity and vice-versa, depending on the point of dispatch and the point of delivery.

In an embodiment of the present invention, the data storage module may further be configured to store mapping data corresponding to mapping between destination address data of a destination entity and origin address data of an origin entity. Practically, a destination entity may be served by a plurality of origin entities. The origin entities serving a particular destination entity may be changed periodically, randomly or on-need basis. The mapping data for each of the origin-destination entity pair reflects the ease of delivering a package from the origin entity to the destination entity. The mapping data may be derived from historical data or route data or a combination of both. All past deliveries, whether successful and unsuccessful, from an origin entity to a destination entity, are reflected in the historical data. The route data reflects the data that affects delivery from the origin entity to the destination entity in real time or near-real time. Such data comprises atleast one of distance data, traffic data, route quality data, route contingency data or the like. The distance data reflects the route distance between an origin entity and a destination entity. Similarly, the traffic data reflects the volume of traffic on the route, the route quality data reflects the quality of route such as quality of roads, weather permissibility for air travel, and the route contingency data reflects any contingencies such as diversions, blockades etc. between an origin entity and a destination entity. The mapping data is updated periodically e.g. after every delivery attempt, randomly or on-need basis e.g. when a large number of deliveries have to be made.

The processing module may assign each of the above variables in the historical data and the route data a weightage based on which the processing module may be able to calculate the mapping data i.e. the ease of delivering from an origin entity to a destination entity. The processing module may also take into account other parameters such as cost, time, convenience, preference or any other such parameter into account while computing the mapping data.

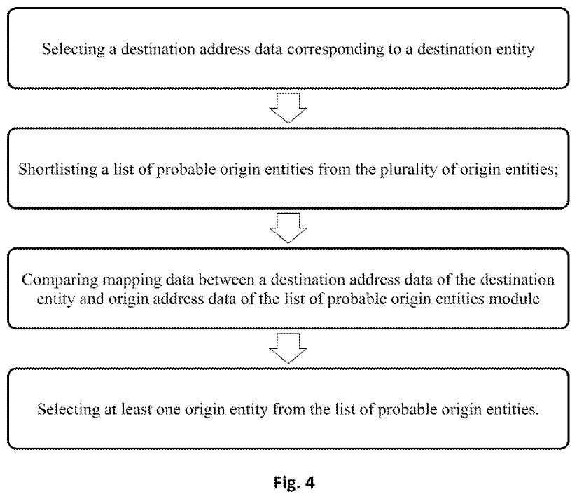

Next, there is described a delivery determination system in FIG. 4, according to one embodiment of the present invention.

A destination address data for a destination entity is selected by the processing module in accordance with the instructions stored in memory module. The destination entity denotes the entity to which a delivery is to be made. The destination entity may be selected by the processing module according to an address data received by the processing module from a remote communication device (not shown) in real time or it may be pre-stored in data storage module. The processing module selects a destination address data corresponding to the destination entity.

The processing module identifies at least one origin entity against the selected destination entity from the list of plurality of origin entities stored in the data storage module.

In an embodiment of the present invention, the processing module may first populate a list of probable origin entities from which the atleast one origin entity may be selected.

In order to populate a list of probable origin entities, the processing module may check the mapping data between the destination address data of the selected destination entity and the origin address data of the plurality of origin entities.

The processing module may check the mapping data between each pair of the selected destination entity and the plurality of origin entities stored in the data storage module.

Alternatively, the processing module may check the mapping for each destination-origin entity pair that has non-null mapping data corresponding to the selected destination entity. Illustratively, a destination entity may have been served by five origin entities in the past. Hence, that destination entity shall have non-null mapping data with only those five origin entities and have null mapping data with other origin entities stored in the data storage module. Therefore, the processing module may identify these five origin entities in order to populate a list of probable origin entities.

More preferably, or in combination, the processing module may shortlist a list of probable origin entities from the list of entities stored in the storage module based destination address data of the destination entity.

Consider the following destination address data for a destination entity:

HN-2134, ABC Enclave, PQR Colony, Sector 91, Gurgaon 122505, Haryana

Herein, the processing module may identify a plurality of hierarchical addressing blocks from the destination address data of the destination entity, such as:

State: Haryana

City: Gurgaon

Locality: Sector 91

Sub-Locality: PQR Colony

Building: ABC Enclave

House Number: 2134

The processing module may select at least one addressing block from the plurality of hierarchical addressing blocks so identified. The processing module may shortlist all origin entities which service the selected addressing block as probable origin entities. As in the above example, the processing module selects ‘Sub-Locality: PQR Colony’ as the selected addressing block. The processing module then selects all the origin entities which serve the selected addressing block i.e. ‘Sub-Locality: PQR Colony’ as probable origin entities.

The processing module may repeat the above process by selecting other addressing blocks to populate the list of probable origin entities selected for the given destination entity.

Alternatively, or in combination, the processing module may shortlist all the origin entities as probable origin entities that are within a certain distance from the destination entity, say 15 km. In such a case, the processing module may compare the location data corresponding to the location of the destination entity with the location data corresponding to the locations of the plurality of origin entities.

It may be noted here that the processing module may, without limiting the scope of the present invention, employ any other techniques for shortlisting probable origin entities.

The processing module then selects at least one origin entity from the list of probable origin entities. The processing module may select at least one origin entity whose mapping data with the selected destination entity reflects the ease of delivering a package from the origin entity to the selected destination entity to be above a threshold limit. Preferably, the origin entity whose mapping data with the selected destination entity reflects the highest ease of delivering a package from the origin entity to the selected destination entity is chosen.

The disclosure is operational with numerous other general purpose or special purpose computing system environments or configurations. Examples of well known computing systems, environments, and/or configurations that may be suitable for use with the disclosure include, but are not limited to, personal computers, server computers, handheld or laptop devices, multiprocessor systems, microprocessor-based systems, set top boxes, programmable consumer electronics, network PCs, minicomputers, mainframe computers, and distributed computing environments that include any of the above systems or devices, and the like.

As used herein, the wording “entity” means any geographical area which may include, but not limited to, buildings, structures, monuments, open areas such as parks, grounds, forests.

1. A system comprising:
one or more processing modules;
one or more data storage modules, operatively coupled to the one or more processing modules, wherein the one or more data storage modules are configured to store at least one of:
an origin address data corresponding to addresses of a plurality of origin entities;
a destination address data corresponding to address of at least one destination entity; and
a mapping data corresponding to mapping between the destination address data and the origin address data;
at least one memory module operatively coupled to the one or more processing modules, wherein the at least one memory module stores instructions which, when executed by the one or more processing modules, causes the one or more processing modules to,
select, from the one or more data storage modules, a destination address data corresponding to an address of a first destination entity; and
select, from the one or more data storage modules, an origin address data corresponding to an address of an origin entity,
wherein the origin address data is selected based on the mapping data corresponding to the mapping between the selected destination address data and the origin address data.

2. The system of claim 1, wherein the mapping data reflects the ease of delivering a package from the origin entity to the destination entity.

3. The system of claim 2, wherein the at least one or more processing modules selects the origin address data based on the mapping data reflecting the highest ease of delivering a package from the origin entity to the destination entity.

4. The system of claim 1, wherein the one or more data storage modules are further configured to store at least one of:
historical data corresponding to past package deliveries from the plurality of origin entities to the destination entity; and
route data from the plurality of origin entities to the destination entity.

5. The system of claim 3, wherein the at least one memory module operatively further stores instructions which, when executed by the one or more processing modules, causes the one or more processing modules to update the mapping data based on at least one of the historical data and the route data.

6. The system of claim 4, wherein the route data comprises at least one of distance data, traffic data, route quality data or route contingency data.

7. The system of claim 1, wherein the mapping data is updated periodically, randomly or on-need basis.

8. A method of selecting an origin entity corresponding to a destination entity from a plurality of origin entities, the method comprising:
shortlisting a list of probable origin entities from the plurality of—origin entities;
comparing mapping data between a destination address data of—the destination entity and origin address data of the list of—probable origin entities; and
selecting at least one origin entity from the list of probable origin—entities.
